(19) United States
(12) Patent Application Publication
(10) Pub. No.: US 2024/0302289 A1
(43) Pub. Date: Sep. 12, 2024

(54) Virtual color sensor for recognizing and distinguishing different-colored objects and in particular containers

(71) Applicant: KRONES AG, Neutraubling (DE)

(72) Inventors: Ahmad ALSHEIKH, Neutraubling (DE); Thomas ALBRECHT, Beilngries (DE)

(21) Appl. No.: 18/598,584

(22) Filed: Mar. 7, 2024

(30) Foreign Application Priority Data
Mar. 7, 2023 (DE) 10 2023 105 672.7

(51) Int. Cl. G01N 21/90; G01N 21/88; G01N 35/00; G01N 35/04

(52) U.S. Cl. CPC G01N 21/909; G01N 21/8851; G01N 21/9009; G01N 35/00732; G01N 35/04; G01N 2021/8887; G01N 2035/00831; G01N 2035/00851; G01N 2035/0493

(57) ABSTRACT

A method for sorting and/or treating containers includes the steps of:
recording at least one image and/or a video of a plurality of containers by an image recording device, which is configured for recording spatially resolved color images;
analyzing the at least one recorded image;
identifying the individual containers;
assigning an identification information and at least one portion of the recorded image to each of the identified containers; and
ascertaining a color information, which is characteristic of an identified container, from the portion of the recorded image.

### BACKGROUND OF THE INVENTION

The present invention relates to a method and an apparatus for sorting objects, and in particular containers, and in particular transported containers. The invention relates more specifically to the field of the beverage production industry, wherein it is known here that different types of beverages are produced within the scope of a particular system. In the production of different flavors of beverages, attention is paid today to not mix the individual types in order to be able to supply them, correctly sorted, to a packaging machine or to move them, correctly sorted, into an intermediate store, from which the individual types are combined in an order-specific manner in a next working step.

The flavors of individual beverage types are to be identified via the color design of the containers and/or the closures thereof. At present, color sensors are used in the prior art, which operate like a type of photoelectric sensor, wherein the light is emitted by a transmitter and the light reflected from the target object, i.e., the container, is then detected with a receiver.

A color sensor can recognize the received light intensity, for example for the colors red, blue and green, as a result of which the color of the target object can be determined. Such sensors are relatively expensive and not very flexible since each sensor can recognize the color of a single object and the object must face the target color.

When the number of transport devices, such as conveyor belts, is increased, the number of sensors must therefore also be increased in order to cover a particular region of the belts. In addition, the color information of the containers is lost after passing through the sensor region.

Due to the sequential transport of different flavors and/or containers and/or products on beverage filling lines, buffers and transport capacities are not optimally utilized or the achievement of a very high degree of flexibility is made more difficult. Order picking of mixed containers requires the temporary storage of the individual types and their order-specific removal and packaging, which leads to a high technical outlay and is also unfavorable in terms of space and resources.

The current color sensors recognize the color of a single object or container and preferably forward this information to an actuator. However, this technology is also limited with respect to the amount of colors to be recognized, and it is difficult to recognize the type when the object contains characters or other visual elements that can interfere the color intensity. Furthermore, it is a problem if each sensor is limited to the recognition of a single object color at the same time.

DE 10 2018 124 712 A1 discloses a work system and a method for carrying out work on an object and robot. In this case, an optical sensor is provided, which is secured on a moving platform and outputs successive optical information about an object.

EP 3 618 976 B1 describes an apparatus and a method for selecting containers moving at high speed.

From DE 10 2013 207 139 A1, a method for monitoring and controlling a filling system and an apparatus for carrying out this method are known. In this case, image sequences are recorded in a region of a filling system and the image sequences are evaluated by calculating an optical flow from an image sequence in a specified number of individual images.

DE 10 2016 211 910 A1 describes an inspection apparatus in an inspection method for inspecting containers arranged in an empties box. In this case, a head is provided with grippers arranged in several gripper rows, in order to grip the containers and take them out of the empties box. In addition, an optical inspection system is provided for inspecting the containers moved out of the empties box with the grippers.

EP 1 446 656 B1 describes a method and a device for producing a robust reference image of a container and for selecting a container. In this case, an image recording of a part of the exterior of a plurality of containers is recorded, and these images are processed in order to obtain a flat representation, wherein the image information is stretched relative to the image information in the center of the recording to a certain degree in the direction of both sides. Subsequently, the complete circumferential view is then assembled over 360° of the exterior of a reference container.

Proceeding from the aforementioned prior art, the object is to improve the throughput of such systems and the reliability of the sorting process. In addition, the object of the person skilled in the art is to make a corresponding apparatus more cost effective.

### SUMMARY OF THE INVENTION

In a method according to the invention for sorting and/or treating containers, at least one image and/or video (and/or an image sequence or a plurality of images) of a plurality of containers is recorded by an image recording device, which is suitable and intended for recording spatially resolved color images. In a further method step, this recorded image is analyzed. Furthermore, containers are identified within the image. Preferably, these containers are also individually identified, i.e., preferably each individual container that was recorded by the image or the image recording device.

In a further step, an identification information and at least one portion of the recorded image are assigned to each of the identified containers.

In a further step, a color information is determined, which is characteristic of an identified container, wherein this color information is determined from the portion of the recorded image.

A multi-stage method is therefore proposed. First, an image is recorded, wherein this image in particular shows a plurality of containers. Subsequently, the image is analyzed to the effect that the image is subdivided into image portions that show the individual containers. In this way, the individual containers are also identified. Subsequently, the aforementioned assignment to the image portion and/or the identified container and identification information takes place.

Preferably, triples (or n-tuples) can be formed, which are composed of said portion of the recorded image, the container shown in this portion, and the identification information thereof.

A color sensor and in particular a virtual color sensor for recognizing and distinguishing different-colored objects and in particular containers is therefore preferably used.

The image recording device is preferably used as a color sensor, in particular as part of such a color sensor, in particular using an image evaluation device or image analysis device. The terms “image evaluation” and “image analysis” are used synonymously below.

A video or an image sequence is preferably recorded by the image recording device. Preferably, an evaluation and/or analysis of a plurality of images or frames of this video or of this image sequence takes place.

The color information which are determined from the image portion can in turn be assigned to the particular container and in particular also to this container via the identification information. Preferably, several steps, in particular successive and/or coordinated steps, are carried out, which are preferably carried out by an algorithms. As mentioned above, images or videos are recorded by the image recording device and in particular by a camera system, and the corresponding image information is then transmitted.

Particularly preferably, this image information is transferred to a computer system, which is preferably a computer system that is close to the machine or integrated. The image evaluation can preferably be carried out with the aid of this computer system.

Preferably, when a video is recorded, an image evaluation of individual images of this video also takes place.

The image information can preferably originate from a life video stream. In addition, it would also be possible that, in particular for training the algorithm or artificial intelligence, the image information originates from a recorded video.

Particularly preferably, individual images or the individual images of this video stream are first analyzed by means of an image recognition algorithm, and the existing objects and in particular the existing containers (on which the algorithm was preferably previously trained) are particularly preferably recognized. This preferably takes place using a neural network.

The method in this case preferably comprises that the image recognition or a corresponding image recognition device and/or (image) analysis device is provided with a container identification model, which is in particular trainable.

The container identification model is preferably a container identification model of machine learning, which is in particular trainable and comprises a set of parameters, which are in particular trainable and are set to values that have been learned as a result of a training process.

The analysis device or image evaluation device preferably processes the retrieved (specified) plurality of spatially resolved data of the image recording device and/or the image data or data derived therefrom, using the container identification model of machine learning, which is in particular trainable. The at least one output variable and/or information is preferably determined thereby and/or on the basis of this processing (preferably in a computer-implemented method step).

Preferably, by processing (spatially resolved) data of the image recording device and/or the image data with respect to at least one container, preferably with respect to several containers, in the recorded image and preferably with respect to all containers in the recorded image, using the container identification model, at least one container state variable and preferably a plurality of container state variables is determined. This container state variable can, for example, be data characteristic of the contour of a container or of a container region. In addition, the container state variable can also be a typical contour of the container(s), for example. For example, contours of detected objects can be taken from the recorded image and these contours can be used as reference variables.

Preferably, the at least one container state variable relates to (in particular exactly) one, in particular predetermined, class of a container state or a region of the container. It would thus be conceivable for the container state variable to relate to a particular contour of the container (e.g., a contour that is characteristic of a particular type of containers, e.g., of cans or particular glass bottles).

The container state variable is preferably characteristic of a probability of the presence of this class of a container state in the processed, spatially resolved image data (of the containers represented in the spatially resolved image data).

For the classification of the spatially resolved image data to be processed, at least one class of a container state of a container and preferably a plurality of classes of container states is preferably predetermined to the container identification model. These predetermined classes can, for example, be learned or typical contours of particular container types or contours of particular components of containers (e.g., container closures).

The container identification model of machine learning is preferably based on an (artificial) neural network. Preferably, the determination of the output variable, in particular of a container type or of a container recognition, is (thus in particular) based on a or the (artificial) neural network. In particular, the spatially resolved sensor data and/or image data (of the retrieved plurality of spatially resolved sensor data and/or image data) are processed by means of the (artificial) neural network, which is in particular trained.

The neural network is preferably designed as a deep neural network (DNN), in which the parameterizable processing chain has a plurality of processing layers, and/or a so called convolutional neural network (CNN) and/or a recurrent neural network (RNN).

The data (to be processed), in particular the spatially resolved sensor data and/or image data (or data derived therefrom), are preferably supplied as input variables to the container identification model or the (artificial) neural network. The container identification model or the artificial neural network preferably maps the input variables as a function of a parameterizable processing chain to output variables, wherein the container state variable is preferably selected as the output variable or a plurality of container state variables are preferably selected as output variables.

The container identification model of machine learning or the artificial neural network is preferably trained using predetermined training data, wherein the training parameterizes the parameterizable processing chain.

In a preferred method, training data comprising a plurality of spatially resolved image data (of containers or container groups) captured by the at least one image recording device are used in the training process of the container identification model. This offers the advantage that the training process is already specifically matched to the container inspection apparatus to be set and specific circumstances of the specific container identification apparatus, such as optical properties of the image recording device or of an illumination device or also specific light conditions in the apparatus, can thus, for example, be directly taken into account.

The spatially resolved image data (captured by the at least one image recording device) provided for use as training data are preferably provided with (container) type and/or classification features. The spatially resolved image data together with the (container) type and/or classification features assigned thereto are preferably stored as a training data set (in particular in one and/or the non-volatile storage device).

A plurality of training data sets is preferably generated in this way. The classification features can be the (above-described) classes of a container state and/or a container state variable relating thereto. For example, the spatially resolved image data assigned to a container can be classified with the types of defects occurring therein, and the like. Note: The specific training data are preferably supplied to a central data set in order to train a superordinate algorithm, which includes all information and data and functions as a global data pool; alternatively, a central algorithm can also be gradually retrained with the specific data in order to develop it to such an extent that it reaches a status in which the training effort for recognizing new objects can be significantly reduced.

It is also conceivable (additionally or alternatively) that the training data used are spatially resolved image data of container groups (or data derived therefrom) that were captured by an image recording device of (at least) one other, preferably structurally identical, container identification apparatus (preferably from the same manufacturer). This offers the advantage that a wide plurality of image data can thereby be provided and used.

It is also conceivable that the training data used are spatially resolved sensor data (or data derived therefrom) generated (exclusively or partially) synthetically or generated via augmentation (data augmentation). This offers the advantage that, for example, rarely occurring classes of container states (or in this case in particular rare container types, such as oval containers or containers with particularly designed regions) can be simulated thereby and the machine learning model can thus be trained in an efficient manner.

The training process can in this case be performed locally (in the container identification apparatus and/or the setting device) and/or centrally and/or locally independently and/or on an external server with respect to the container identification apparatus.

A neural network trained in this way (within the scope and/or as a container identification model) is preferably used. Training is preferably carried out by means of monitored learning. However, it would also be possible to train the container identification model or the artificial neural network by means of not monitored learning, reinforcement learning, or stochastic learning.

For evaluating the spatially resolved image data, the image evaluation device preferably processes these image data, or data derived therefrom, using the container identification model. By using the container identification model, at least one (computer-implemented) computer vision method is used, in which (computer-implemented) perception and/or detection tasks are performed, e.g., (computer-implemented) 2D and/or 3D object recognition methods and/or (computer-implemented) methods for semantic segmentation and/or (computer-implemented) object classification (“image classification”) and/or (computer-implemented) object localization and/or (computer-implemented) edge recognition.

The spatially resolved image data or data derived therefrom are preferably supplied to the container identification model as input variables. The container inspection model preferably outputs at least one container state variable, and preferably the plurality of container state variables, as output variable.

In this case, in the case of object classification, an object that was captured and/or represented in the spatially resolved sensor data, or data derived therefrom, with respect to a container is preferably assigned to a (or the previously learned and/or predetermined) class of a container state.

In the case of object localization or object identification, in particular in addition to an object classification, a location of an object captured and/or represented in the spatially resolved sensor data is determined or ascertained (in particular with respect to the spatially resolved sensor data and/or image data), which is in particular marked and/or highlighted by a bounding box. In the case of semantic segmentation, each pixel of the spatially resolved sensor data or data derived therefrom is in particular assigned (classes annotation) a class of a container state or a class of the container type (for classification of an object) (in particular from a plurality, in particular a predetermined plurality, of classes of a container state and/or a plurality of container types).

In this case, the classes of a container state and/or of the container type (for classification of the spatially resolved image data, or data derived therefrom, with respect to a container) are preferably the and/or some and/or all of the classes described above of container states and/or container types.

This evaluation is preferably carried out for each re-encoded or streamed frame and/or image of the camera, and several and particularly preferably all containers are preferably identified in this frame or this image.

Preferably, each (identified) container is subsequently assigned an unique identification information, in particular a unique ID, and the latter is particularly preferably assigned to a detail of the container and/or of the recorded image for the next step of color recognition. This assignment is preferably stored. Note: This ID is retained even if the images of several cameras are joined together. The identification can thus take place across several images, image sequences, that are attached to one another or merged with one another, from several cameras.

It is thus possible for the individual image portions to show complete containers, but it would also be possible for the images to show only parts of individual containers, e.g., their cover portions. This assignment in particular takes place for the subsequent step of color recognition.

Preferably, the ID or the identification information also makes it possible to not only find the container in camera coordinates but to preferably also transfer it into a global coordinate system. As mentioned in detail below, this coordinate system can be used on an actuator in order to further ascertain and/or determine a suitable response for a particular object.

The container preferably retains this identification information, which particularly preferably is or describes a unique identification of the container and/or which describes the container variant over the entire region to be monitored.

The image detail from the object recognition step is preferably used further for a color determination. In this case, it is possible and preferred for the color structure to be subdivided during the variant, for example if a container has different flavors. In this case, each type can be recognized by several colors. These colors are preferably the target colors, and the latter construct or form a color structure. In addition, a particular variant can also be marked by this color palette.

A plurality of images or a video is particularly preferably recorded. The containers particularly preferably differ at least partially by their colors and/or color compositions.

In this context, it is pointed out that the term “containers” is understood to mean not only the actual containers but preferably also any accessories of these containers, such as labels or container closures or prints.

The containers are preferably closed and/or labeled and can in particular be distinguished by color.

Preferably, several images of a video stream are analyzed.

As mentioned above, the identification information makes it possible to find a container both in camera coordinates and in superordinate coordinates.

Particularly preferably, several types of containers are detected, preferably at least three, preferably at least four, and preferably at least five different types. These types preferably have different properties and in particular different color properties.

For example, these properties can be different flavors of a liquid contained in the containers, and in particular of a beverage. These different containers preferably have particular properties in each case, in particular as mentioned above, flavor properties. These properties are preferably associated with different accessory features, such as in particular but not exclusively different labels, different closures, and/or different prints.

Particularly preferably, the images or videos are recorded in a reflected-light method. The containers are preferably illuminated and the image recording device records images of the illuminated containers and/or container regions.

The image recording device preferably records at least the upper sides of the containers.

If, for example, n containers are found in a recorded image, it is possible to subdivide the image into n portions, e.g., 20 portions, which preferably each show a container and/or a part of a container.

Furthermore, preferably, each container is assigned one portion, and this portion is in turn assigned an identification information, which can subsequently be used further.

In a further preferred method, an actuator device and/or sorting device, which is suitable and intended for acting on the identified container, is controlled taking into account the color information.

The color information can be used to deduce the container and/or its content. Accordingly, said actuator device can be controlled in order, for example, to guide and/or direct the container in a particular direction, for example onto a particular further transport belt.

The actuator device is therefore preferably suitable and intended for treating containers that were identified as belonging to different types due to the color information ascertained for these containers, differently.

In a preferred method, the actuator device is selected from a group of actuator devices, which selected robots, robot arms, impact devices for ejecting and/or displacing individual containers from the transport path, switches for discharging individual containers from the transport path, or the like.

In a further preferred method, a transport device transports the containers along a predetermined transport path, and the at least one image or video of the containers is preferably recorded during the transport of the containers. For example, the transport device can be a transport belt or transport belts or also several transport chains.

The containers are particularly preferably transported in a straight line. The containers are particularly preferably transported upright. In a further preferred method, the containers are transported in groups and/or in a cluster.

In a further preferred method, the containers are transported unordered and/or in a random sequence.

In a further preferred method, the at least one image is analyzed by means of an image recognition algorithm.

In a further preferred method, individual containers or container regions are identified by means of an algorithm.

In a further preferred method, the color information is determined by an algorithm.

Preferably, at least two of the aforementioned steps take place by an algorithm. These two steps can be the first and the third as well as the first and second as well as the second and the third step.

Preferably, all three of the steps mentioned take place by an algorithm.

Particularly preferably, at least two and preferably at least three algorithms are therefore used in succession. In this way, the existing objects, in particular containers, can be recognized and/or identified.

In a further preferred method, all containers in a recorded image are identified.

In a further preferred method, the image detail from the object or container recognition step is used for a color determination. In a further preferred method, a target color is sought in the image or the image detail, and the information as to how much of this color is present in the image detail and/or to which proportion this color is present in the image detail is returned. The search method can in this case take place, as described in more detail below, using different color systems.

In a further preferred method, a container in camera coordinates is found by the identification information, and/or the identification information is transferred to a superordinate coordinate system. As mentioned above, this superordinate coordinate system can be used by the actuator device, in particular for the control thereof.

In a further preferred method, a particular color or color group is assigned to each container or container region or container type. In this way, conversely, if a particular color information is present, the type of container can be deduced. In a further preferred method, at least one color and preferably a plurality of colors is found in the image portion. Particularly preferably, the container is deduced on the basis of proportions of the individual colors.

For example, a particular image portion can have 20% red portions (in the case of pixel-wise evaluation). This can then be used as an indication of a particular container type. In addition, more complex evaluations are however also conceivable. For example, the color information can consist in that the image portion contains about 20% red and 20% green. This color information can also be used to identify a container.

In a further preferred method, the recorded image is evaluated pixel-wise.

As mentioned above, the colors are found using at least one color system, wherein the color system is preferably selected from a group of color systems that contains HSV, L*A*B, and YCbCr. A system for a color is preferably selected as a function of this color. The method searches for this color within the potential region and particularly preferably returns how many pixels (of the recorded image and/frame) fall into this color category.

In this case, it is possible, for example, that different shades of colors are assigned to one particular color; for example, different shades of red are in each case characterized as red, different shades of blue as blue, and the like. In this way, the calculation of a color intensity is possible and the latter is preferably also used to determine a second and/or third target color.

Preferably, a construct of the container variant can be based on a predefined set of variant names. The variant name can be a color palette, which establishes a color structure.

In this way, it is possible to recognize a container variant with this method. Particularly preferably, target colors are defined on a container cover or a container side.

A different color system can preferably be selected as a function of the color.

It is particularly preferably indicated, and in particular indicated pixel-wise, how many pixels have a particular color. In this way, the intensity of the color can also be determined.

In a further preferred embodiment, the analysis of the at least one recorded image, the identification of the individual containers, and/or the determination of the color information is carried out using artificial intelligence.

For determining the color information, only a portion of the recorded image is preferably evaluated, and particularly preferably only a portion of an image portion showing a container. Preferably, only the regions of an image portion that show the container or regions of the container shown in the image portion are evaluated.

In this case, for each image pixel or for image pixel groups, it is preferably decided whether they reproduce a region of the container (or also with what probability these image pixels reproduce a particular region of the container).

The procedure for determine the color information can be similar to what was described above with reference to the container identification.

For this purpose, the apparatus preferably has a color evaluation device, which is suitable and intended for determining color information from a recorded image and in particular a portion of the recorded image that shows a container and/or a portion of the container.

The method furthermore comprises that the apparatus is provided with a color evaluation model, which is in particular trainable.

The color evaluation model is preferably a color evaluation machine model of machine learning, which is in particular trainable. Preferably, as a result and/or on the basis of this processing, the at least one item of color information is determined (preferably in a computer-implemented method step).

Preferably, by processing (spatially resolved) image data with respect to (exactly) one container using the color evaluation model, at least one item of color information and/or at least one color value is determined.

The at least one item of color information preferably relates to (in particular exactly) one container, which is in particular predetermined, or to the region of a container. The color information is preferably characteristic of a probability of the presence of a color of a container or of a particular region of a container in the processed, spatially resolved image data (of the container or container region represented in the spatially resolved image data).

Preferably predetermined to the color evaluation model for the classification of the spatially resolved image data to be processed is at least one class of color information of a container and preferably a plurality of color information of containers or container regions.

The color evaluation model of machine learning is preferably based on an (artificial) neural network. The determination of the color information is (thus in particular) preferably based on a or the (artificial) neural network. In particular, the spatially resolved image data (of the retrieved plurality of spatially resolved image data) are processed by means of the (artificial) neural network, which is in particular trained.

The neural network is preferably designed as a deep neural network (DNN), in which the parameterizable processing chain has a plurality of processing layers, and/or a so called convolutional neural network (CNN) and/or a recurrent neural network (RNN).

The data (to be processed), in particular the spatially resolved sensor data (or data derived therefrom), are preferably supplied as input variables to the color evaluation model or the (artificial) neural network. The color evaluation model or the artificial neural network preferably maps the input variables as a function of a parameterizable processing chain to output variables, wherein the container color (or the color of the evaluated region of the container) is preferably selected as the output variable or a plurality of container colors are preferably selected as output variables.

The color evaluation model of machine learning or the artificial neural network is preferably trained using predetermined training data, wherein the training parameterizes the parameterizable processing chain.

In a preferred method, training data comprising a plurality of spatially resolved image data (of containers or container groups) captured by the at least one image recording device are used in the training process of the color evaluation model. This offers the advantage that the training process is already specifically matched to the apparatus to be set and specific circumstances of the specific apparatus, such as optical properties of the image recording device or also specific light conditions in the apparatus, can thus, for example, be directly taken into account.

The spatially resolved image data (captured by the at least one image recording device) provided for use as training data are preferably provided with (container) type and/or classification features. The spatially resolved image data together with the (container) type and/or classification features assigned thereto are preferably stored as a training data set (in particular in one and/or the non-volatile storage device). A plurality of training data sets is preferably generated in this way. The classification features can be the (above-described) classes of colors of the containers or container regions, and/or a state variable relating thereto. For example, the spatially resolved image data assigned to a container can be classified with the types of defects occurring therein, and the like.

It is also conceivable (additionally or alternatively) that the training data used are spatially resolved image data of containers (or data derived therefrom) that were captured by an image recording device of (at least) one other, preferably structurally identical, apparatus (preferably from the same manufacturer). This offers the advantage that a large plurality of image data can thereby be provided and used.

It is also conceivable that the training data used are spatially resolved image data (or data derived therefrom) generated (exclusively or partially) synthetically or generated via augmentation (data augmentation). This offers the advantage that, for example, rarely occurring classes of container states or rare containers can be simulated thereby and the model of machine learning can thus be trained in an efficient manner.

The training process can in this case be performed locally (in the apparatus and/or the color evaluation device) and/or centrally and/or locally independently and/or on an external server and/or in the cloud with respect to the apparatus.

A neural network trained in this way (within the scope and/or as a color evaluation model) is preferably used. Training is preferably carried out by means of monitored learning. However, it would also be possible to train the color evaluation model or the artificial neural network by means of not monitored learning, reinforcement learning, or stochastic learning.

For evaluating the spatially resolved sensor data, the color evaluation device preferably processes these image data, or data derived therefrom, using the color evaluation model. By using the color evaluation model, at least one (computer-implemented) computer vision method is used, in which (computer-implemented) perception and/or detection tasks are performed, e.g., (computer-implemented) 2D and/or 3D object recognition methods and/or (computer-implemented) methods for semantic segmentation and/or (computer-implemented) object classification (“image classification”) and/or (computer-implemented) object localization and/or (computer-implemented) edge recognition.

The spatially resolved image data or data derived therefrom are preferably supplied to the color evaluation model as input variables. The color evaluation model preferably outputs at least one container state variable, and preferably the plurality of container state variables, as output variable. As mentioned above, these variables are in particular color values and/or color information.

In this case, in the case of object classification, an object that was detected and/or represented in the spatially resolved image data, or data derived therefrom, with respect to a container (or a container region) is assigned to a (or the previously learned and/or predetermined) class of a container state (in particular of a color information).

In a further preferred method, the determined color structure of an image portion is assigned to a particular container, a particular container region, or a particular container type. This can, for example, take place using particular color proportions.

Particularly preferably, an image portion contains a particular container or a particular container region. This image portion preferably has particular colors or color proportions. From these color proportions, it is possible to deduce the type of the container and, preferably, the aforementioned actuator device can also initiate a particular measure, e.g., guide said container onto a particular transport belt or onto a particular forwarding transport belt.

The present invention is furthermore directed to an apparatus for sorting or identifying containers, wherein the apparatus has a transport device, which transports the containers along a specified transport path, and wherein the apparatus has at least one image recording device for recording at least one image and/or video of a plurality of containers and in particular of containers transported (by the transport device), wherein the image recording device is suitable and intended for recording spatially resolved color images.

Furthermore, the apparatus has an analysis device for analyzing the recorded image or the recorded images, which analysis device is suitable and intended for identifying an individual container within the recorded image or also for identifying a region of an individual container within the recorded image.

According to the invention, the apparatus has an assignment device, which is suitable and intended for assigning an image portion of the recorded image, which image portion preferably contains the identified container, to an identification information.

Furthermore, a color information determination device is provided, which is suitable and intended for determining a color information characteristic of this container and/or this image portion. Alternatively, the color information determination device can also be suitable for determining color information characteristic of a container portion or container region and/or of this image portion.

In a further preferred embodiment, the transport device conveys the containers in a cluster and in particular unordered.

In a further preferred method, in particular by means of the analysis device, it is also possible to detect a position of the containers (with respect to the transport device) and/or other geometric properties, such as a diameter of the container(s) and/or the central axes. Image portions can also be generated in this way.

Particularly preferably, the color information contains color proportions, at least one color proportion of a particular color, and/or several color proportions of several colors.

In a further advantageous embodiment, an image portion generation unit is provided, which subdivides the image into several portions, which preferably each show a container or a container region. This can in particular also take place by evaluating the image.

In a further advantageous embodiment, the apparatus has a storage device for storing images or image portions. Both newly recorded images and the corresponding image portions can in this case be stored. In addition, however, reference images or reference image portions can also be stored, with the aid of which artificial intelligence can undertake the corresponding evaluation of the images. In a further advantageous embodiment, a comparison device is provided, which compares recorded images with previously stored images or which compares recorded image portions with stored image portions.

Particularly preferably, the apparatus has an AI (artificial intelligence) unit.

In a further advantageous embodiment, the apparatus has an actuator device for sorting and/or for acting on the containers, wherein a control device is furthermore preferably provided, which controls this actuator device and/or sorting device as a function of the color information characteristic of the container. Preferably, this actuator device is arranged downstream of the image recording device in the transport direction of the containers.

The apparatus preferably has a trigger device for triggering the actuator device. This trigger device can be light barriers, for example. In addition, however, it would also be conceivable that the image recording device is also triggered.

In a further method, the image recording device records a video, from which individual or also consecutive images are evaluated, for example.

In a further advantageous embodiment, the apparatus has an illumination device which illuminates the containers with a predetermined light source. Advantageously, this is a uniform illumination. In this way, it can also be ensured that the same color information is always output for a particular container. In a preferred embodiment, the illumination device has a white light source.

It is thus possible, for example, for color information to be determined that contains 30% red, 20% green, and 10% blue. This color information can be assigned to a particular type of container, which is, for example, stored in a storage device. It can thus be determined from the color information that the container in the corresponding image portion is a container of type A, and the actuator device can be controlled accordingly.

The present invention is furthermore directed to a system for beverage production with a filling device for filling containers and an apparatus of the type described above, which apparatus is downstream of this filling device.

As mentioned above, an alternative of the procedure according to the invention can also consist in that a specific point, such as a center of the container, is, for example, known from an object recognition or the container recognition. In addition, the container diameter can also be known. In this way, many regions can therefore be constructed, and the dominant color in each region can be determined. In this way, it would be possible to determine the color information on the basis of, for example, a closure cap of a container or also on the basis of a liquid that is located in the container or also on the basis of the color information that, for example, results from a label. Several of these procedures can also be combined.

In this case, a dominant color can preferably be determined in each region. In addition, it would also be possible for a variant name to represent the dominant color in a particular region. In this context, it is pointed out that black and white and shades of gray are preferably also regarded as colors within the scope of this application.

Furthermore, it would be possible to mark the two regions of the container, e.g., to define them with circles. However, other shapes are also possible. The search for the color preferably takes place only within these regions mentioned. In this case, a particular region of the recorded container can, for example, be marked in an image or image portion and can be evaluated accordingly in terms of color.

With the aid of the invention, regions of a beverage filling, of a container transport system, of a machine outlet or else of a container treatment machine can be monitored and preferably monitored in real time. In this case, containers of different types along with their colors and positions can be determined. This preferably enables an actuator system to carry out a suitable and accurate response, for example by generating a continuous signal and supplying a control system of the actuator device.

If an actuator device is not used, the invention can also be used to determine the number of transported container types.

In a preferred embodiment, the apparatus therefore has a counting device, which is suitable and intended for determining the number of particular container types within an image portion or also within a particular transport section.

In addition, the system described here is very flexible and can find any type and size of containers and also the respective color combinations in order to determine the container variant as a result.

This can take place without a further model having to be trained beforehand in order to find a variant.

In addition, the invention can also be used for automated labeling of image data. The images thus labeled can subsequently be used for training a neural network, the quality of which preferably continuously increases as a result of repeated training with different image data.

Further advantages and embodiments can be seen in the accompanying drawings:

### BRIEF DESCRIPTION OF THE DRAWINGS

In the drawings:

FIG. 1 shows a schematic representation for illustrating the method according to the invention;

FIG. 2 shows a representation of the evaluation of a recorded image portion; and

FIG. 3 shows a further representation of the evaluation of a recorded image portion.

### DETAILED DESCRIPTION OF THE INVENTION

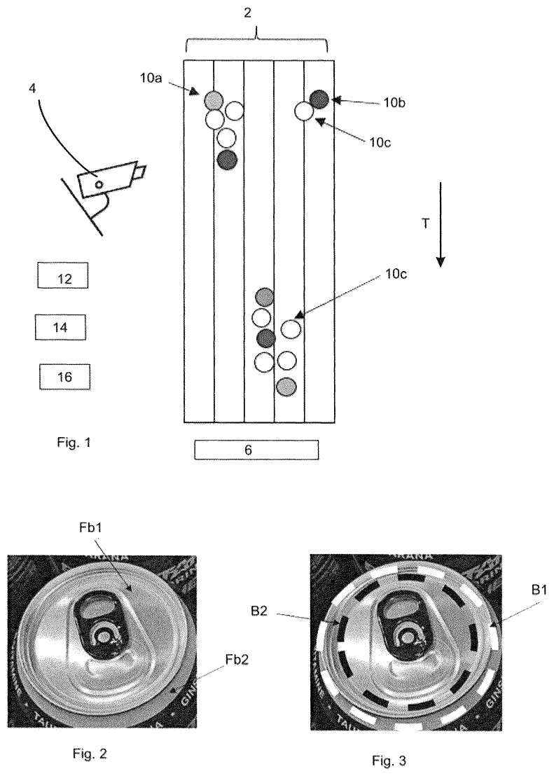

FIG. 1 shows a schematic representation of an apparatus according to the invention. This apparatus has a transport device 2. This transport device 2 transports three types of containers 10a, 10b, 10c along a transport path T. Here, the containers are containers of three different types. For example, these types can be three types of containers or beverages, which differ in particular by the colors of the containers, by their closures, by their cover regions, or the like.

An image recording device 4, which is in particular a camera, records images and in particular videos of the containers 10a, 10b, 10c transported by the transport device 2.

It can be seen that the containers are transported in groups here. All of the containers 10a, 10b, 10c shown are preferably captured by the image recording device 4.

Reference sign 12 denotes an image evaluation device or image analysis device, which evaluates and/or analyzes the recorded images (and/or videos). This (image) analysis device preferably identifies the individual containers 10a, 10b, 10c in the recorded images, but preferably still independently of their type.

An image portion forming device 14 preferably subdivides one or more recorded images, wherein for each image shows one of the containers or a portion thereof.

An assignment device preferably assigns an identification information, which is in particular unique, to each of these image portions and/or to each of the identified containers.

A color evaluation device 16 preferably evaluates the individual image portions in terms of color and preferably outputs at least one color information for each image portion (and thus for each container shown in this image portion).

Additionally, other values that are characteristic of this container, such as a height, a cross-section, or the like, can also be output.

Reference sign 6 denotes an actuator device and in particular a sorting device, such as a robot, which is preferably controlled using the color information for each individual container 10a, 10b, 10c. This actuator device can preferably sort the individual identified containers.

FIG. 2 shows an image portion of a recorded image. This image portion here shows a cover region of a can. From this image portion, two items of color information or two target colors and/or corresponding color regions Fb1 and Fb2 can be determined here, wherein one target color is characteristic of a cover region of the can and one target color is characteristic of an edge region or wall region.

FIG. 3 shows an alternative recognition procedure. This alternative consists in that the center of the object, i.e., here of the can, is known from the object recognition, and thus also the container diameter. Many regions B1, B2 can therefore be constructed, and the dominant color in each region can be determined. This is indicated by the dashed lines. A dominant color can be determined for each region. It would also be possible that these regions, here the two regions are defined, e.g., are defined with circles. Other shapes are also possible; the search for the color preferably takes place only within these two regions.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. A method for sorting and/or treating containers, comprising the steps of:
recording at least one image and/or a video of a plurality of containers by an image recording device, which is configured for recording spatially resolved color images;
analyzing the at least one recorded image;
identifying the individual containers;
assigning an identification information and at least one portion of the recorded image to each of the identified containers; and
determining a color information, which is characteristic of an identified container, from the portion of the recorded image.

2. The method according to claim 1,
wherein
an actuator device and/or sorting device, which is configured for acting on the identified container, is controlled taking into account the color information.

3. The method according to claim 2,
wherein
the actuator device is selected from a group of actuator devices, which contains robots, robot arms, impact devices for ejecting individual containers from the transport path, switches for discharging individual containers from the transport path, or the like.

4. The method according to claim 1,
wherein
a transport device transports the containers along a predetermined transport path, and the at least one image or video of the containers is recorded during the transport of the containers.

5. The method according to claim 1,
wherein
the at least one image is analyzed by an image recognition algorithm, and/or the individual containers or container regions are identified by an algorithm, and/or the color information is determined by an algorithm.

6. The method according to claim 1,
wherein
all containers in a recorded image are identified.

7. The method according to claim 1,
wherein
a container in camera coordinates is found by the identification information, and/or the identification information is transferred to a superordinate coordinate system.

8. The method according to claim 1,
wherein
a particular color or color group is assigned to each container or container type.

9. The method according to claim 1,
wherein
at least one color is found in the image portion and the container is deduced on the basis of proportions of the individual colors.

10. The method according to claim 9,
wherein
the colors are found using at least one color system, wherein the color system is selected from a group of color systems that contains HSV, L*A*B, and YCbCr.

11. The method according to claim 1,
wherein
the analysis of the at least one recorded image, the identification of the individual containers, and/or the determination of the color information takes place using an artificial intelligence.

12. The method according to claim 9,
wherein
a determined color structure of an image portion is assigned to a particular container or a particular container type.

13. An apparatus for sorting and/or identifying containers, wherein the apparatus has a transport device configured to transport the containers along a predetermined transport path, and wherein the apparatus has at least one image recording device configured for recording at least one image and/or a video of a plurality of containers transported by the transport device, and wherein the image recording device is configured for recording spatially resolved color images, wherein the apparatus furthermore comprises an analysis device configured for analyzing the recorded image, which analysis device is configured for identifying an individual container within the recorded image,
wherein
the apparatus has a first assignment device, which is configured for assigning identification information to an image portion, containing the identified container, of the recorded image, and a color information determination device, which is configured for determining color information characteristic of this container and/or of this image portion.

14. The apparatus according to claim 13,
wherein
the apparatus has an actuator device configured for acting on the containers, wherein a control device is furthermore provided, which controls this actuator device as a function of the color information characteristic of the container.

15. The apparatus according to claim 13,
wherein
the apparatus has a second assignment device, configured to assign a container type to the color information characteristic of the image portion and/or the container.
